(19) United States
(12) Patent Application Publication
(10) Pub. No.: US 2026/0065551 A1
(43) Pub. Date: Mar. 5, 2026

(54) ELECTRONIC DEVICE AND METHOD OF CONTROLLING SAME

(71) Applicant: SAMSUNG ELECTRONICS CO., LTD., Suwon-si (KR)

(72) Inventors: Minchul LEE, Suwon-si (KR); Aron BAIK, Suwon-si (KR); Beomjin KIM, Suwon-si (KR); Hyeongsik MIN, Suwon-si (KR)

(73) Assignee: SAMSUNG ELECTRONICS CO., LTD., Suwon-si (KR)

(21) Appl. No.: 19/278,395

(22) Filed: Jul. 23, 2025

Related U.S. Application Data
(63) Continuation of application No. PCT/KR2025/009381, filed on Jul. 1, 2025.

(30) Foreign Application Priority Data
Sep. 3, 2024 (KR) 10-2024-0119194

(51) Int. Cl. G06T 11/60; G06T 5/20; G06T 5/60

(52) U.S. Cl. CPC G06T 11/60; G06T 5/20; G06T 5/60; G06T 2200/24; G06T 2207/20081; G06T 2207/20084

(57) ABSTRACT

An electronic device includes memory storing instructions; and at least one processor, wherein the instructions, when executed, cause the electronic device to receive an input prompt; identify feature information in a first portion of a first generated image based on the input prompt; obtain a modified prompt by modifying the input prompt based on the feature information; obtain candidate images of a first image quality corresponding to the modified prompt using a first generative artificial intelligence (AI) model; display a user interface (UI) including the candidate images via a display; and based on a selected candidate image being identified from among the candidate images, obtain a second generated image of a second image quality corresponding to the selected candidate image, wherein a second image quality parameter of the second generated image is higher than a first image quality parameter of the first generated image.

### CROSS-REFERENCE TO RELATED APPLICATION

This application is a continuation application of International Patent Application No. PCT/KR2025/009381, filed on Jul. 1, 2025, which claims priority from Korean Patent Application No. 10-2024-0119194, filed on Sep. 3, 2024, in the Korean Intellectual Property Office, the disclosures of which are incorporated herein by reference in their entireties.

### BACKGROUND

### 1. Field

The disclosure relates to an electronic device and a method of controlling the same, and to an electronic device for obtaining a generated image based on a prompt input by a user, and a method of controlling the same.

### 2. Description of Related Art

Recently, various images may be generated by using a generative AI model. An electronic device such as a refrigerator may obtain a generated high quality image based on a prompt by performing processing via an external server.

In the past, if a prompt was obtained according to a user's input, and the prompt was transmitted to an external server, the server obtained a generated image corresponding to the prompt by using a generative AI model, and an electronic device received the generated image from the server and performed upscaling, and provided the generated image of a high resolution to the user.

A process of performing upscaling in an electronic device after generating and transmitting an image required a substantial amount of time consumed until a user viewed a generated image of a high resolution. As an example, the server may take several seconds to generate an image of a middle size, and more time was needed to transmit an image, in addition to several additional seconds for upscaling the image by the electronic device. Due to this, the user had to wait an excessive amount of time before the user could identify an image to be set as a background screen, significantly degrading the user experience. Moreover, if a generated image was not accepted by the user, a significant amount of additional time would be required to repeat the process.

Other devices and methods for obtaining a generated high quality are therefore needed.

### SUMMARY

According to an aspect of the disclosure, an electronic device includes memory storing one or more instructions; and at least one processor, wherein the one or more instructions, when executed by the at least one processor individually or collectively, cause the electronic device to receive an input prompt, identify feature information in a first portion of a first generated image based on the input prompt; obtain a modified prompt by modifying the input prompt based on the feature information; obtain a plurality of candidate images of a first image quality corresponding to the modified prompt using a first generative artificial intelligence (AI) model for generating an output image based on input text; display a user interface (UI) including the plurality of candidate images via a display; and based on a selected candidate image being identified from among the plurality of candidate images, obtain a second generated image of a second image quality corresponding to the selected candidate image, wherein a second image quality parameter of the second generated image is higher than a first image quality parameter of the first generated image.

The one or more instructions, when executed by the at least one processor individually or collectively, may cause the electronic device to modify the input prompt to include text indicating to modify a first area corresponding to the first portion of the first generated image to increase a third image quality parameter in the first area, and modify a second area corresponding to a second portion of the first generated image surrounding the first portion to decrease a fourth image quality parameter in the second area.

The electronic device may further include a communication interface, and the one or more instructions, when executed by the at least one processor individually or collectively, may cause the electronic device to modify the input prompt to include text indicating to generate the second generated image with the second image quality, and based on information obtained from at least one of the memory or over a network via the communication interface, compress the second generated image.

The electronic device may further include a communication interface, the first generative AI model may be stored in a storage of an external server, and the one or more instructions, when executed by the at least one processor individually or collectively, may cause the electronic device to transmit the modified prompt to the external server via the communication interface to cause the external server to input the modified prompt into the first generative AI model; and receive the plurality of candidate images from the external server while the external server processes the modified prompt via the first generative AI model.

The electronic device may cause the external server to generate a plurality of images corresponding to the plurality of candidate images, via at least one neural network model for increasing at least one image quality parameter, based on the electronic device requesting the plurality of candidate images, and the one or more instructions, when executed by the at least one processor individually or collectively, may cause the electronic device to, based on the selected candidate image being identified, receive the second generated image from the external server via the communication interface.

The electronic device may cause the external server to obtain a plurality of seed values corresponding to the plurality of candidate images, via a second generative AI model for generating an output image based on input text, based on the electronic device requesting the plurality of candidate images, and the one or more instructions, when executed by the at least one processor individually or collectively, may cause the electronic device to receive the second generated image from the external server based on transmitting to the external server a seed value corresponding to the selected candidate image.

The electronic device may further include a communication interface, the first generative AI model may be stored the memory, and the one or more instructions, when executed by the at least one processor individually or collectively, may cause the electronic device to obtain the plurality of candidate images by inputting the modified prompt into the first generative AI model; and while displaying the UI including the plurality of candidate images, transmit the plurality of candidate images and a plurality of seed values corresponding to the plurality of candidate images to an external server via the communication interface.

The one or more instructions, when executed by the at least one processor individually or collectively, may cause the electronic device to, based on the selected candidate image being identified, receive from the external server, via the communication interface, the second generated image based on transmitting a seed value corresponding to the selected candidate image to the external server.

The electronic device may further include a camera, and the one or more instructions, when executed by the at least one processor individually or collectively, may cause the electronic device to capture an interior image of the electronic device via the camera; obtain information relating to an object in the interior image; and obtain the modified prompt by incorporating the information relating to the object into the input prompt.

The one or more instructions, when executed by the at least one processor individually or collectively, may cause the electronic device to set the second generated image as a background screen of the electronic device.

According to an aspect of the disclosure, a controlling method of an electronic device includes receiving an input prompt; identifying feature information in a first portion of a first generated image based on the input prompt; obtaining a modified prompt by modifying the input prompt based on the feature information; obtaining a plurality of candidate images of a first image quality corresponding to the modified prompt using a first generative artificial intelligence (AI) model for generating an output image based on input text; displaying a user interface (UI) including the plurality of candidate images via a display; and based on a selected candidate image being identified from among the plurality of candidate images, obtaining a second generated image of a second image quality corresponding to the selected candidate image, wherein a second image quality parameter of the second generated image is higher than a first image quality parameter of the first generated image.

The obtaining the modified prompt may include modifying the input prompt to include text indicating to modify a first area corresponding to the first portion of the first generated image to increase a third image quality parameter in the first area, and modify a second area corresponding to a second portion of the first generated image surrounding the first portion to decrease a fourth image quality parameter in the second area.

The obtaining the modified prompt may include modifying the input prompt to include text indicating to generate the second generated image with the second image quality, and based on information obtained from at least one of a memory of the electronic device or over a network via a communication interface, compress the second generated image.

The first generative AI model may be stored in a storage of an external server, and the obtaining the plurality of candidate images may include transmitting the modified prompt to the external server via a communication interface to cause the external server to input the modified prompt into the first generative AI model; and receiving the plurality of candidate images from the external server while the external server processes the modified prompt via the first generative AI model.

The external server may be caused to generate a plurality of images corresponding to the plurality of candidate images, via at least one neural network model for increasing at least one image quality parameter, based on the electronic device requesting the plurality of candidate images from the external server, and the obtaining the second generated image may include, based on the selected candidate image being identified, receiving the second generated image from the external server via the communication interface.

The external server may be caused to obtain a plurality of seed values corresponding to the plurality of candidate images, via a second generative AI model for generating an output image based on input text, based on requesting the plurality of candidate images, and the obtaining the second generated image may include receiving the second generated image from the external server based on transmitting to the external server a seed value corresponding to the selected candidate image.

The first generative AI model may be stored memory of the electronic device, the obtaining the plurality of candidate images may include obtaining the plurality of candidate images by inputting the modified prompt into the first generative AI model, and the obtaining the second generated image may include, while displaying the UI including the plurality of candidate images, transmitting the plurality of candidate images and a plurality of seed values corresponding to the plurality of candidate images to an external server via a communication interface.

The obtaining the second generated image may include, based on the selected candidate image being identified, receiving from the external server, via the communication interface, the second generated image based on transmitting a seed value corresponding to the selected candidate image to the external server.

The controlling method may further include capturing an interior image of the electronic device via a camera; obtaining information relating to an object in the interior image; and obtaining the modified prompt by incorporating the information relating to the object into the input prompt.

According to an aspect of the disclosure, a non-transitory computer-readable recording medium having instructions recorded thereon, that, when executed by at least one processor individually or collectively, cause the at least one processor to receive an input prompt; identify feature information in a first portion of a first generated image based on the input prompt; obtain a modified prompt by modifying the input prompt based on the feature information; obtain a plurality of candidate images of a first image quality corresponding to the modified prompt using a first generative artificial intelligence (AI) model for generating an output image based on input text; display a user interface (UI) including the plurality of candidate images via a display; and based on a selected candidate image being identified from among the plurality of candidate images, obtain a second generated image of a second image quality corresponding to the selected candidate image, wherein a second image quality parameter of the second generated image is higher than a first image quality parameter of the first generated image.

### BRIEF DESCRIPTION OF THE DRAWINGS

The above and other aspects, features, and advantages of certain embodiments of the present disclosure are more apparent from the following description taken in conjunction with the accompanying drawings, in which:

With respect to the detailed description of the drawings, identical or similar components may be designated by identical or similar reference numerals.

FIG. 1 is a diagram illustrating a system for obtaining a generated image according to an embodiment;

FIG. 2 is a block diagram illustrating a configuration of an electronic device according to an embodiment;

FIG. 3 is a block diagram illustrating a configuration of an electronic device for obtaining an image corresponding to a prompt according to an embodiment;

FIG. 4 is a sequence diagram for illustrating an embodiment for obtaining an image corresponding to a prompt according to an embodiment;

FIG. 5 is a diagram illustrating a UI for obtaining a prompt according to an embodiment;

FIG. 6 is a flow chart for illustrating a method of modifying a prompt according to an embodiment;

FIG. 7 is a diagram illustrating a UI including a plurality of candidate images according to an embodiment;

FIG. 8 is a sequence diagram for illustrating an embodiment for obtaining an image corresponding to a prompt according to another embodiment; and

FIG. 9 is a flow chart for illustrating a controlling method of an electronic device for obtaining an image corresponding to a prompt according to an embodiment.

### DETAILED DESCRIPTION

The embodiments described in the disclosure, and the configurations shown in the drawings, are only examples of embodiments, and various modifications may be made without departing from the scope and spirit of the disclosure.

Various modifications may be made to the embodiments, and there may be various types of embodiments. Embodiments will be illustrated in drawings, and the embodiments will be described in detail in the detailed description. It should be noted that the various embodiments are not for limiting the scope of the disclosure to a embodiment, but they should be interpreted to include various modifications, equivalents, and/or alternatives of the embodiments. With respect to the detailed description of the drawings, similar components may be designated by similar reference numerals.

The embodiments described below may be modified in various different forms, and the scope of the technical idea of the disclosure is not limited to the embodiments below. Rather, these embodiments are provided to make the disclosure more sufficient and complete, and to fully convey the technical idea of the disclosure to those skilled in the art.

The terms used in the disclosure are used only to explain embodiments, and are not intended to limit the scope of the disclosure. Singular expressions include plural expressions, unless indicated otherwise.

Expressions such as “have,” “may have,” “include,” and “may include” denote the existence of such characteristics (e.g.: elements such as numbers, functions, operations, and components), and do not exclude the existence of additional characteristics.

The expressions “A or B,” “at least one of A and/or B,” or “one or more of A and/or B” and the like may include all possible combinations of the listed items. For example, “A or B,” “at least one of A and B,” or “at least one of A or B” may refer to all of the following cases: (1) including at least one A, (2) including at least one B, or (3) including at least one A and at least one B.

The expressions “first,” “second,” and the like used in the disclosure may describe various elements regardless of any order and/or degree of importance. Such expressions are used only to distinguish one element from another element, and are not intended to limit the elements.

The description in the disclosure that one element (e.g.: a first element) is “(operatively or communicatively) coupled with/to” or “connected to” another element (e.g.: a second element) should be interpreted to include both the case where the one element is directly coupled to the another element, and the case where the one element is coupled to the another element through still another element (e.g.: a third element).

In contrast, the description that one element (e.g.: a first element) is “directly coupled” or “directly connected” to another element (e.g.: a second element) can be interpreted to mean that still another element (e.g.: a third element) does not exist between the one element and the another element.

The expression “configured to” used in the disclosure may be interchangeably used with other expressions such as “for,” “having the capacity to,” “designed to,” “adapted to,” “made to,” and “capable of,” depending on cases. The term “configured to” may not necessarily mean that a device is “designed to” in terms of hardware.

Instead, under some circumstances, the expression “a device configured to” may mean that the device “is capable of” performing an operation together with another device or component. For example, the phrase “a processor configured to perform A, B, and C” may mean a dedicated processor (e.g.: an embedded processor) for performing the corresponding operations, or a-purpose processor (e.g.: a CPU or an application processor) that can perform the corresponding operations by executing one or more software programs stored in a memory device.

In the embodiments, ‘a module’ or ‘a part’ may perform at least one function or operation, and may be implemented as hardware or software, or as a combination of hardware and software. A plurality of ‘modules’ or ‘parts’ may be integrated into at least one module and implemented as at least one processor, excluding ‘a module’ or ‘a part’ that is indicated to be implemented with hardware.

Various elements and areas in the drawings were illustrated schematically. The technical idea of the disclosure is not limited by the relative sizes or intervals illustrated in the accompanying drawings.

The meaning of the feature that the electronic device 100 “provides” information may include not only the feature of displaying information through an output device included in the electronic device 100 (e.g., a display 120), but also the feature of transmitting information to a user terminal communicatively connected to the electronic device 100 and displaying information through a display of the user terminal.

Throughout the disclosure, “an image quality,” or “an image quality parameter,” may not only mean a resolution, but also include details of an image, the depth of a color, a contrast ratio, a frame rate, or whether there is a noise, for example. “Increasing” an image quality parameter, or a “higher” image quality, may include, for example, increasing a resolution, increasing details, increasing color depth, increasing a contrast ratio, increasing a frame rate, or reducing noise. “Decreasing” an image quality parameter, or a “lower image quality may include, for example, decreasing a resolution, decreasing details, decreasing color depth, decreasing a contrast ratio, decreasing a frame rate, or increasing noise.

The disclosure will be described in detail with reference to the drawings.

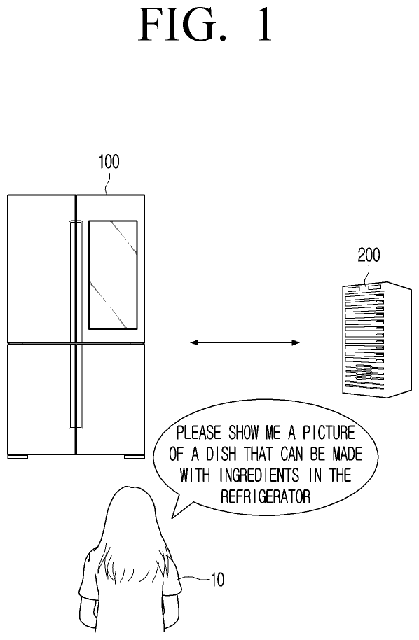

FIG. 1 is a diagram illustrating a system for obtaining a generated image according to an embodiment. As illustrated in FIG. 1, a system may include an electronic device 100 and an external server 200. Here, as illustrated in FIG. 1, the electronic device 100 may be implemented as a refrigerator, but this is one example, and the electronic device 100 may be implemented as a home appliance such as a TV, a washing machine, an air conditioner, and a cooking device, and may also be implemented as a user terminal such as a smartphone, a tablet PC, or a laptop PC, for example. The external server 200 may be implemented as one server, but this is one example, and it be implemented as a plurality of servers.

The electronic device 100 may receive a user input for obtaining a prompt. Here, the prompt may mean an input for initiating an interaction with a generative AI model, and it may be in a text form. According to an embodiment, a user input may be a user voice, but this is one example, and a user input may be implemented as a user touch for inputting a text through a text window, or a user touch for selecting a UI element on a UI for generating a prompt, for example, but is not limited thereto.

The electronic device 100 may modify the prompt for obtaining a generated image swiftly and efficiently. According to an embodiment, the electronic device 100 may identify a feature part of a generated image based on the prompt, and modify the prompt based on the identified feature part of the generated image. According to an embodiment, the electronic device 100 may modify the prompt based on information on the electronic device 100 (e.g., performance information) and network information. According to an embodiment, the electronic device 100 may modify the prompt based on information on an object related to the electronic device 100 (an object stored inside the electronic device 100, for example).

The electronic device 100 may transmit the modified prompt to the external server 200. Here, the external server 200 may include a generative AI model and at least one neural network model for improvement of an image quality. The external server 200 may obtain a plurality of candidate images by inputting the prompt received from the electronic device 100 into the generative AI model. Here, the candidate images may be images of a low image quality.

The external server 200 may transmit the plurality of generated candidate images to the electronic device 100. The external server 200 may input the plurality of candidate images into the at least one neural network model and obtain a generated image of a high image quality.

The electronic device 100 may display a UI including a plurality of candidate images, and select one of the plurality of candidate images according to a user input. The electronic device 100 may transmit information on the selected candidate image to the external server 200.

The external server 200 may identify a generated image corresponding to the selected candidate image among the plurality of generated images, and transmit the image to the electronic device 100. For example, the external server 200 has obtained a plurality of generated images in advance, and thus it can immediately transmit a generated image of a high image quality corresponding to the candidate image selected by the user to the electronic device 100 without a separate delay time. By this, the user can obtain a generated image of a high image quality corresponding to the prompt more quickly.

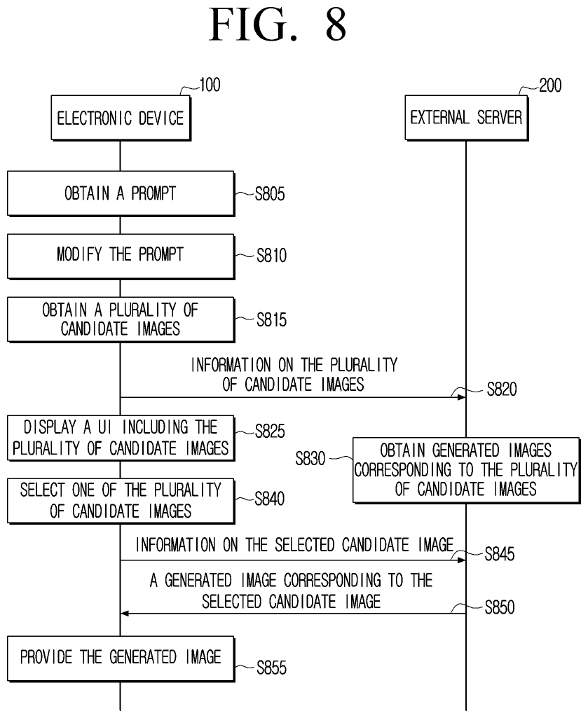

In the embodiment, it was explained that the external server 200 obtains a plurality of candidate images by using the generative AI model. This is one example, and the electronic device 100 can obtain a plurality of candidate images by using the generative AI model. Detailed explanation in this regard will be described later with reference to FIG. 8.

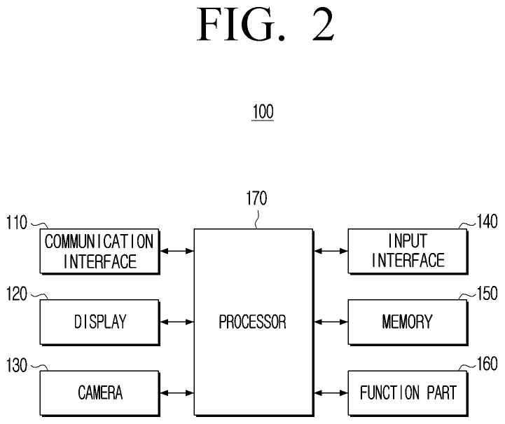

FIG. 2 is a block diagram illustrating a configuration of an electronic device according to an embodiment. As illustrated in FIG. 2, the electronic device 100 may include a communication interface 110, a display 120, a camera 130, a user input interface 140, memory 150, a function part 160, and a processor 170. The components illustrated in FIG. 2 are one example, and, depending on the implementation of the electronic device 100, some components can be added.

The communication interface 110 may perform communication with the external server 200 or an external terminal device. The communication interface 110 may transmit a prompt to the external server 200, and receive a plurality of candidate images corresponding to the prompt from the external server 200. The communication interface 110 may transmit information on a selected candidate image to the external server 200, and receive a generated image corresponding to the selected candidate image from the external server 200.

The communication interface 110 may perform communication with various types of external devices by using various wireless communication technologies or mobile communication technologies. Wireless communication technologies such as Bluetooth, Bluetooth Low Energy, CAN communication, Wi-Fi, Wi-Fi Direct, ultra-wideband (UWB) communication, Zigbee, infrared Data Association (IrDA), or near field communication (NFC), for example, may be included, and mobile communication technologies such as 3GPP, Wi-Max, Long Term Evolution (LTE), or 5G, for example, may be included.

The display 120 may provide various types of information. The display 120 may display a UI for generating a prompt and a UI including a plurality of candidate images. The display 120 may provide a generated image corresponding to a candidate image selected by the user. Here, the generated image may be set as a background screen.

If the electronic device 100 is implemented as a refrigerator, for example, the display 120 may be arranged on some of a plurality of doors of the refrigerator.

The camera 130 is a component for photographing a subject and generating a photographed image, and here, the photographed image may include both of a moving image and a still image. Throughout the disclosure, “an image” may include both of an image output on the display 120 and an image frame photographed by the camera 110.

If the electronic device 100 is implemented as a refrigerator, for example, the camera 110 may photograph a storage chamber inside the main body of the refrigerator and a door bin (or a door basket, a pantry) area of the door. The camera 130 may be provided in the upper area of the inside of the main body for photographing at least a part of the inside of the main body and the door bin area of the door. The camera 130 may be provided in the side surface area or the lower area of the inside of the main body for photographing at least a part of the inside of the main body. The camera 130 may be provided outside the refrigerator and photograph the outside of the refrigerator. The camera 130 can not only be implemented as one camera, but also be implemented as a plurality of cameras depending on embodiments.

The processor 170 may obtain information on an object included inside the electronic device 100 from an image photographed by the camera 130.

The user input interface 140 may include a button, a lever, a switch, a touch type interface, or a microphone, for example. Here, the touch type interface may be implemented by a method of receiving input by the user's touch on the screen of the display 120 of the electronic device 100.

The user input interface 140 may receive a user input for obtaining a prompt, or a user input for selecting one of a plurality of candidate images, for example.

The memory 150 may store an operating system (OS) for controlling the overall operations of the components of the electronic device 100 and instructions or data related to the components of the electronic device 100. The memory 150 may include various modules for obtaining a generated image corresponding to a prompt. If an event for obtaining a generated image corresponding to a prompt occurs, the electronic device 100 may load data for the various modules stored in the non-volatile memory to perform various types of operations on the volatile memory. Here, loading means an operation of calling in data stored in the non-volatile memory to the volatile memory and storing the data, so that the processor 170 can access the data.

The memory 150 may be implemented as non-volatile memory (ex: a hard disc, a solid state drive (SSD), flash memory), or volatile memory (which may include memory inside the processor 170), for example.

According to an embodiment, the memory 150 may store a generative AI model for generating a plurality of candidate images corresponding to a prompt.

The function part 160 may perform various functions of the electronic device 100. For example, in case the electronic device 100 is implemented as a refrigerator, the function part 160 may include components for keeping food refrigerated or frozen. As another example, in case the electronic device 100 is implemented as a washing machine, the function part 160 may include components for washing laundry.

The processor 170 may control the electronic device 100 according to at least one instruction stored in the memory 150.

The processor 170 may include one or more processors. The one or more processors may include one or more of a central processing unit (CPU), a graphics processing unit (GPU), an accelerated processing unit (APU), a many integrated core (MIC), a digital signal processor (DSP), a neural processing unit (NPU), a hardware accelerator, or a machine learning accelerator. The one or more processors may control one or a random combination of the other components of the electronic device 100, and perform an operation related to communication or data processing. The one or more processors may execute one or more programs or instructions stored in the memory. For example, the at least one processor may perform the method according to an embodiment by executing the one or more instructions stored in the memory. For example, the one or more processors may perform the method according to an embodiment by executing the one or more instructions stored in the memory.

In case the method according to an embodiment includes a plurality of operations, the plurality of operations may be performed by one processor, or performed by a plurality of processors. For example, when a first operation, a second operation, and a third operation are performed by the method according to an embodiment, all of the first operation, the second operation, and the third operation may be performed by a first processor, or the first operation and the second operation may be performed by the first processor (for example, a central processing unit (CPU)), and the third operation may be performed by a second processor (for example, a graphics processing unit (GPU) or a neural processing unit (NPU)). For example, according to an embodiment, an operation of identifying a corner in a handwriting image or correcting a space in a handwriting image by using a neural network model, for example, may be performed by a processor performing a parallel operation such as a GPU or an NPU, and an operation of generating/editing a plan image or a post-processing operation, for example, may be performed by a CPU.

The at least one processor may be implemented as a single core processor including one core, or may be implemented as one or more multicore processors including a plurality of cores (e.g., multicores of the same kind or multicores of different kinds). In case the at least one processor is implemented as multicore processors, each of the plurality of cores included in the multicore processors may include internal memory of the processor such as cache memory, or on-chip memory, for example, and common cache shared by the plurality of cores may be included in the multicore processors. Each of the plurality of cores (or some of the plurality of cores) included in the multicore processors may independently read a program instruction for implementing the method according to an embodiment and perform the instruction, or the plurality of entire cores (or some of the cores) may be linked with one another, and read a program instruction for implementing the method according to an embodiment and perform the instruction.

In case the method according to an embodiment includes a plurality of operations, the plurality of operations may be performed by one core among the plurality of cores included in the multicore processors, or they may be performed by the plurality of cores. For example, when the first operation, the second operation, and the third operation are performed by the method according to an embodiment, all of the first operation, the second operation, and the third operation may be performed by a first core included in the multicore processors, or the first operation and the second operation may be performed by the first core included in the multicore processors, and the third operation may be performed by a second core included in the multicore processors.

In the embodiments, the processor 170 may mean a system on chip (SoC) wherein at least one processor and other electronic components are integrated, a single core processor, a multicore processor, or a core included in the single core processor or the multicore processor. Here, the core may be implemented as a CPU, a GPU, an APU, a MIC, a DSP, an NPU, a hardware accelerator, or a machine learning accelerator, for example, but the embodiments are not limited thereto.

The processor 170 may receive input of a prompt for generating an image by executing the at least one instruction stored in the memory 150, identify information in a portion of a generated image based on the prompt, modify the prompt based on the information on the feature part of the image, obtain a plurality of candidate images of a first image quality corresponding to the modified prompt by using a generative AI model for generating an image corresponding to a text, display a UI including the plurality of candidate images through the display 120, and based on one of the plurality of candidate images being selected, obtain a generated image of a second image quality corresponding to the selected candidate image. Here, the second image quality is a higher image quality than the first image quality.

According to an embodiment, the processor 170 may modify the prompt to include a text that makes an area corresponding to the feature part of the image generated in a high image quality, and makes an area corresponding to the surrounding part of the image generated in a low image quality.

According to an embodiment, the processor 170 may modify the prompt to include a text that makes the second image quality of the generated image and whether to compress the image determined based on information on the electronic device 100 and network information.

According to an embodiment, the generative AI model may be stored in the external server 200, and the processor 170 may transmit the modified prompt to the external server 200 through the communication interface 110, and based on the plurality of candidate images being obtained as the external server 200 inputs the modified prompt into the generative AI model, receive the plurality of candidate images from the external server 200.

According to an embodiment, the external server 200 may include at least one neural network model for improving an image quality. Here, the external server 200 may obtain a plurality of images corresponding to the plurality of candidate images by using the at least one neural network model after transmitting the plurality of candidate images, and based on one of the plurality of candidate images being selected, the processor 170 may receive a generated image of a second image quality corresponding to the selected candidate image among the plurality of images from the external server 200.

According to an embodiment, the external server 200 may obtain the plurality of candidate images and seed values indicating each of the plurality of candidate images by using a generative AI model for generating an image corresponding to a text. The processor 170 may receive the generated image of the second image quality corresponding to the selected candidate image obtained by using a seed value corresponding to the selected candidate image.

According to an embodiment, the memory 150 may store the generative AI model. Here, the processor 170 may obtain the plurality of candidate images of the first image quality corresponding to the modified prompt by inputting the modified prompt into the generative AI model, and while displaying a UI including the plurality of candidate images through the display 120, transmit the plurality of candidate images and seed values indicating each of the plurality of candidate images to the external server 200 through the communication interface 110. Based on one of the plurality of candidate images being selected, the processor 170 may receive the generated image obtained through a seed value corresponding to the selected candidate image from the external server 200 through the communication interface 110.

According to an embodiment, the processor 170 may capture an image of the interior of the electronic device 100 through the camera 130, obtain information on an object included in the image of the interior, and modify the prompt by adding the information on the object to the prompt.

According to an embodiment, the processor 170 may set the generated image as a background screen of the electronic device 100.

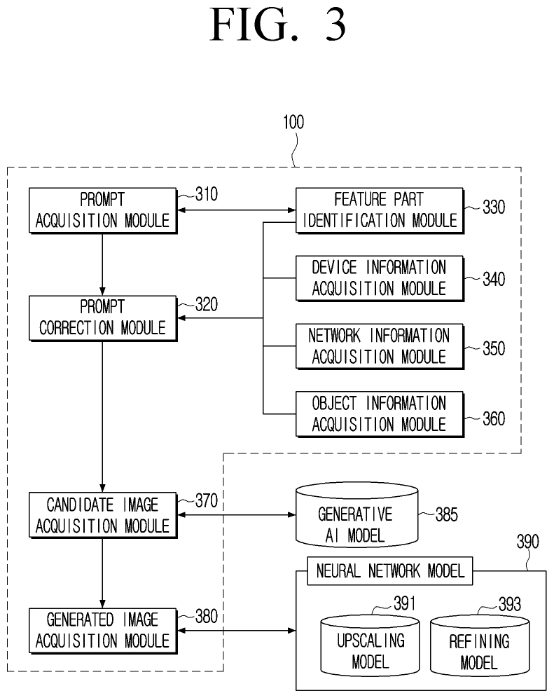

FIG. 3 is a block diagram illustrating a configuration of an electronic device for obtaining an image corresponding to a prompt according to an embodiment. As illustrated in FIG. 3, the electronic device 100 may include a prompt acquisition module 310, a prompt correction module 320, a feature part identification module 330, a device information acquisition module 340, a network information acquisition module 350, an object information acquisition module 360, a candidate image acquisition module 370, and a generated image acquisition module 380. The plurality of modules disclosed in FIG. 3 may be implemented as software, but this is one example, and the modules can be implemented as a combination of software and hardware. According to an embodiment, some modules among the plurality of modules illustrated in FIG. 3 may not be included, and new modules may be further included.

The prompt acquisition module 310 may obtain a prompt for generating an image. “A prompt” according to the disclosure may mean an input for initiating an interaction with the generative AI model. A prompt may be a text input or a voice input including one or more texts and/or one or more sentences. According to an embodiment, a prompt may include a natural language text. In the natural language text, various types of information that can be used for the generative AI model to generate a response for a user inquiry or control the electronic device 100 such as a context, an intent, a task, or constraints, for example, may be included. A prompt may be referred to by being replaced with various expressions indicating an identical/a similar concept. A prompt may be replaced with, for example, expressions such as “an input,” “a user input,” “an input phrase,” “a user command,” “a directive,” “a starting sentence,” “a task query,” “a trigger sentence,” “a message,” for example, but is not limited to the examples. A user voice that is initially input into the electronic device 100 may also be a prompt, but for the convenience of explanation, a user voice that is initially input and a prompt generated by additional information were used distinctively.

According to an embodiment, the prompt acquisition module 310 may obtain a prompt based on a user voice input through the microphone. The prompt acquisition module 310 may receive input of a user voice through the microphone, and perform voice recognition for the user voice and obtain a prompt (or a text) corresponding to the user voice.

According to an embodiment, the prompt acquisition module 310 may obtain a text that was input through a text input UI displayed on the electronic device 100 or a text input UI displayed on a user terminal connected with the electronic device 100 as a prompt.

According to an embodiment, the prompt acquisition module 310 may display a UI for selecting attributes (e.g., a category, a style, a color, for example) of an image that the user desires to generate, and obtain a prompt based on the attributes of the image selected through the UI. For example, if a “cooking” category and a “neat” style are selected through the UI for selecting the category (e.g., cooking, food, for example) of the image and the style (e.g., neat, fancy, for example) of the image, the prompt acquisition module 310 may obtain a prompt such as “Please generate a cooking image in a neat style” based on the selected attributes of the image. Here, the prompt acquisition module 310 may obtain a prompt by inputting information on the selected attributes of the image into a trained neural network model or into a template prompt.

The prompt correction module 320 may correct (or correct, update, for example) the obtained prompt for obtaining an optimal image. The prompt correction module 320 may correct the obtained prompt based on various types of information obtained through the feature part identification module 330, the device information acquisition module 340, the network information acquisition module 350, and the object information acquisition module 360.

According to an embodiment, the prompt correction module 320 may obtain information on the feature part of the generated image obtained through the feature part identification module 330.

The feature part identification module 330 may identify information on the feature part of the generated image based on the prompt. Here, the generated image may be an image that was generated by inputting the prompt into a neural network model including the generative AI model. The feature part of the generated image may be a main area or a target object included in the generated image.

The feature part identification module 330 may identify the feature part of the generated image by identifying a target word (or a main keyword) corresponding to the image that the user desires to generate among a plurality of words included in the prompt. According to an embodiment, the feature part identification module 330 may identify a target word by inputting the prompt into a neural network model for identifying a target word. According to an embodiment, the feature part identification module 330 may identify a target word by identifying an object among the plurality of words. The feature part identification module 330 may identify the feature part of the generated image based on the identified target word.

The prompt correction module 320 may modify the prompt based on the feature part of the generated image identified by the feature part identification module 330. The prompt correction module 320 may modify the prompt to include a text that makes an area corresponding to the feature part of the generated image generated in a high image quality, and makes an area corresponding to the surrounding part of the generated image generated in a low image quality. As an example, if the prompt is “Please draw a dish that can be made with food in the refrigerator,” the feature part identification module 320 may identify “a dish” which is the target word as the feature part of the generated image. The prompt correction module 320 may modify the prompt to include a text which is “Generate the dish part in each image to be clear, and generate the remaining parts to be blurry” based on the feature part of the generated image.

According to an embodiment, the prompt correction module 320 may obtain information on the electronic device 100 and network information through the device information acquisition module 340 and the network information acquisition module 350.

The device information acquisition module 340 may obtain information on the electronic device 100. Here, the information on the electronic device 100 may include identification information and performance information of the electronic device 100. The identification information of the electronic device 100 may include information on the product name, the product number, and the manufacturer of the electronic device 100. The performance information of the electronic device 100 may include use information of the processor 170, use information of the memory 150, battery information of the electronic device 100, display information of the electronic device 100, for example

The device information acquisition module 340 may obtain the information on the electronic device 100 by reading the information on the electronic device 100 stored in the memory 150 of the electronic device 100. The device information acquisition module 340 may receive the information on the electronic device 100 through the external server 200.

The network information acquisition module 350 may obtain information on the network performance of the electronic device 100. Here, the information on the network performance may include at least one of information on the bandwidth, information on the delay time, information on a jitter, information on a packet loss, information on a throughput, or information on the quality of service (QoS). The network information acquisition module 350 may obtain information on the delay time and a packet loss through a ping test, and obtain information on the bandwidth (the download/upload time, for example) through a speed test, and evaluate the processing amount and the bandwidth of the network by using an iPerf. This is one example, and the network information may be obtained through various methods.

The prompt correction module 320 may modify the prompt based on the information on the electronic device 100 and the network information obtained through the device information acquisition module 340 and the network information acquisition module 350. For example, the prompt correction module 320 may modify the prompt to include the information on the electronic device 100 and the network information together with a text such as “Please determine the quality level according to the given network speed. Also, please determine whether to compress the image according to the device specification.”

According to an embodiment, the prompt correction module 320 may obtain information on an object included in the electronic device 100 through the object information acquisition module 360. For example, in case the electronic device 100 is a refrigerator, the object may include groceries, or tableware, for example, kept in the refrigerator.

The object information acquisition module 360 may obtain information on an object included in the electronic device 100 based on an image of the inside of the electronic device 100 photographed through the camera. According to an embodiment, the object information acquisition module 360 may obtain information on the object included in the electronic device 100 by inputting the image of the inside into a neural network model trained to identify an object included in an image.

The prompt correction module 320 may correct based on the information on the object obtained through the object information acquisition module 360. According to an embodiment, if the prompt is “Please draw a dish that can be made with food in the refrigerator,” and the object is “kimchi,” the prompt correction module 320 may modify the prompt to “Please draw a dish that can be made with kimchi” based on the information on the object.

The candidate image acquisition module 370 may obtain a plurality of candidate images corresponding to the modified prompt by using a generative AI model 385.

Here, the generative AI model 385 is an artificial intelligence model that generates a new content based on input data, and it may be a model that generates an image (or a moving image) by inputting a text. According to an embodiment, the generative AI model 385 may be a neural network model that was trained to input a prompt and generate a plurality of candidate images corresponding to the prompt. Here, the plurality of candidate images may be images of a first image quality (or a low image quality). The first image quality may be a low image quality having a resolution of 480p (640×480 pixels) or lower.

According to an embodiment, the generative AI model 385 may be stored in the external server 200. For example, the candidate image acquisition module 370 may transmit the prompt obtained from the prompt correction module 320 to the external server 200. The candidate image acquisition module 370 may receive the plurality of candidate images obtained by inputting the prompt into the generative AI model 385 from the external server 200.

Here, the external server 200 may adjust the image quality of the plurality of candidate images according to the network speed and the performance of the electronic device. For example, in case the network speed is greater than or equal to a threshold value or the performance of the electronic device 100 is high performance, the external server 200 may transmit the plurality of candidate images of the first image quality, and in case the network speed is smaller than the threshold value or the performance of the electronic device 100 is low performance, the external server 200 may transmit the plurality of candidate images that were compressed.

According to an embodiment, the generative AI model 385 may be stored in the memory 150 of the electronic device 100. For example, the candidate image acquisition module 370 may obtain a plurality of candidate images by inputting the prompt obtained from the prompt correction module 320 into the generative AI model 385.

The generative AI model 385 may obtain seed values corresponding to each of a plurality of candidate images when generating the plurality of candidate images. Here, the seed values are values indicating the candidate images, and they may be values that make the neural network model generate the same output for the same input.

In case there is no image desired by the user among the plurality of candidate images, the candidate image acquisition module 370 may request a new candidate image to the external server 200.

The generated image acquisition module 380 may obtain a generated image selected by the user among the plurality of candidate images. Here, the generated image may be an image of a second image quality (or a high image quality). For example, the second image quality may be an image quality having a resolution of 1080p (1920×1080 pixels), 4K (3840×2160 pixels), or higher.

The generated image acquisition module 380 may display a UI including the plurality of candidate images. When a user input for selecting one of the plurality of candidate images is received, the generated image acquisition module 380 may transmit information on the selected candidate image (e.g., a seed value) to the external server 200.

Here, while the user selects one of the plurality of candidate images (or, while the UI including the plurality of candidate images is displayed), the external server 200 may obtain a generated image of the second image quality corresponding to the plurality of candidate images. For example, the external server 200 may generate a plurality of candidate images, and obtain a plurality of generated images corresponding to the plurality of candidate images. The external server 200 stores the plurality of obtained generated images. When information on a selected candidate image among the plurality of candidate images is received, the external server 200 may transmit a generated image corresponding to the selected candidate image to the electronic device 100. By this, the user can obtain a generated image of a high image quality more quickly.

As illustrated in FIG. 3, the external server 200 may obtain generated images of the second image quality corresponding to the candidate images by using at least one neural network model 390. According to an embodiment, the at least one neural network model 390 is a model for improving an image quality of an input image, and may include an upscaling model 391 and a refining model 393.

The upscaling model 391 may be an artificial intelligence model that is used in converting an image (or a moving image) of a low image quality (or a low resolution) into a higher image quality (or resolution), and thereby improving the image quality. The upscaling model 391 may be trained to heighten a resolution of an input image. For example, the upscaling model 391 may be one of a super-resolution convolutional neural network (SRCNN), an enhanced deep super-resolution network (EDSR), or an enhanced super-resolution generative adversarial network (ESRGAN), but is not limited thereto.

The refining model 393 may be an artificial intelligence model used in improving an input image more elaborately and correctly. The refining model 393 may be trained to improve details of an input image. As the refining model 393, an artificial intelligence model based on a generative adversarial network (GAN) may be used, but the disclosure is not limited thereto.

The external server 200 may obtain information on a generated image of the second image quality wherein the resolution has been improved by inputting a candidate image into the upscaling model 391, and obtain a generated image wherein details have been improved by inputting the generated image of the second image quality into the refining model 393. In FIG. 3, the operation order of the upscaling model 391 and the refining model 393 may be changed. For example, the external server 200 may obtain information on a generated image of the first image quality wherein details have been improved by inputting a candidate image into the refining model 393, and obtain a generated image of the second image quality wherein details have been improved by inputting the generated image of the first image quality wherein details have been improved into the upscaling model 391.

In FIG. 3, it was explained that the at least one neural network model 390 includes the upscaling model 391 and the refining model 393. This is one example, and the at least one neural network model 390 may further include an additional neural network model (e.g., a noise removal model, for example) other than the upscaling model 391 and the refining model 393.

In FIG. 3, it was explained that the neural network model 390 includes a plurality of neural network models 391, 393, but this is one example, and the neural network model 390 may be implemented as one neural network model for improving an image quality of an image (for example, a neural network model wherein the upscaling model 391 and the refining model 393 were integrated).

The generated image acquisition module 380 may receive the generated image of the second image quality corresponding to the selected candidate image from the external server 200. The generated image acquisition module 380 may provide the generated image of the second image quality through the display 120, and store the image in the memory 150. The generated image acquisition module 380 may set the obtained generated image as the background screen.

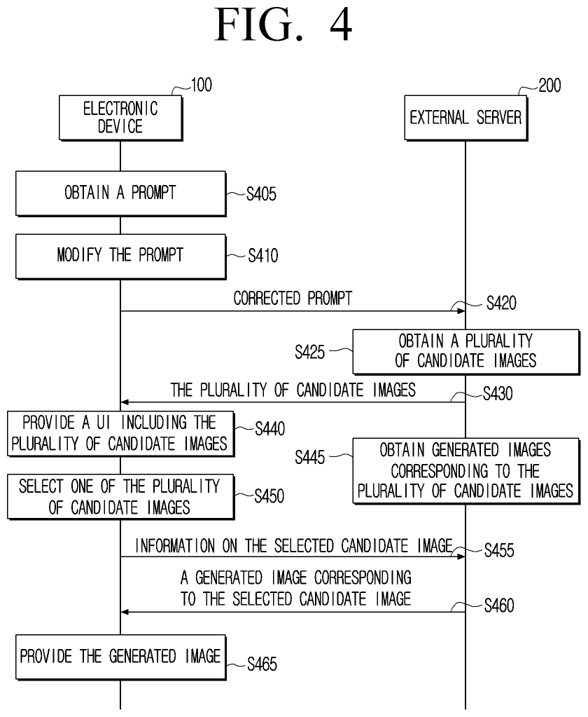

FIG. 4 is a sequence diagram for illustrating an embodiment for obtaining an image corresponding to a prompt according to an embodiment. In the embodiments below, each operation may be performed sequentially, but the operations are not necessarily performed sequentially. For example, the order of each operation may be changed, and at least two operations may be performed in parallel.

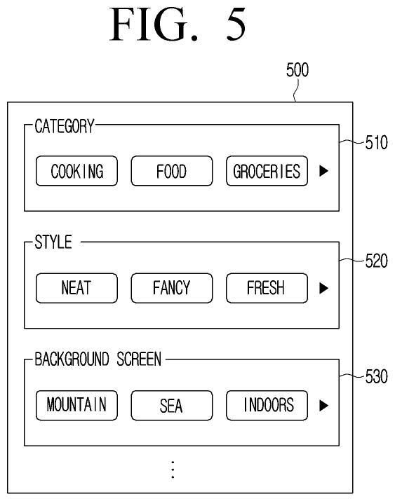

The electronic device 100 may obtain a prompt in operation S405. Here, the prompt may be obtained based on a user input for obtaining a generated image. According to an embodiment, the electronic device 100 may receive input of a user voice through the microphone. The electronic device 100 may obtain a text corresponding to the obtained user voice as a prompt through automatic speech recognition (ASR). According to an embodiment, the electronic device 100 may display a UI for inputting characters on the display 120. The electronic device 100 may obtain a text input through the UI for inputting characters as a prompt. According to an embodiment, the electronic device 100 may obtain a text obtained by a user terminal as a prompt. Here, the user terminal may obtain a text based on a user voice input through a microphone or obtain a text through a UI for inputting characters. According to an embodiment, the electronic device 100 may display a UI for obtaining a prompt. Here, the UI for obtaining a prompt may include UI elements for selecting a keyword to be input into a prompt. For example, as illustrated in FIG. 5, the electronic device 100 may display a UI 500 including UI elements for selecting a keyword to be input into a prompt such as a category 510 of a generated image, a style 520 of a generated image, and a background screen 530 of a generated image, for example. When a keyword to be input into a prompt is selected through the UI 500, the electronic device 100 may generate a prompt by inputting the selected keyword into a pre-stored template prompt. For example, while a template prompt which is “Please generate a ZZZ image with a YYY background screen having an XXX style” is stored, if “a cooking category,” “a neat style,” and “an indoor background screen” are selected through the UI 500, the electronic device 100 may obtain a prompt such as “Please generate a cooking image with an indoor background screen having a neat style.”

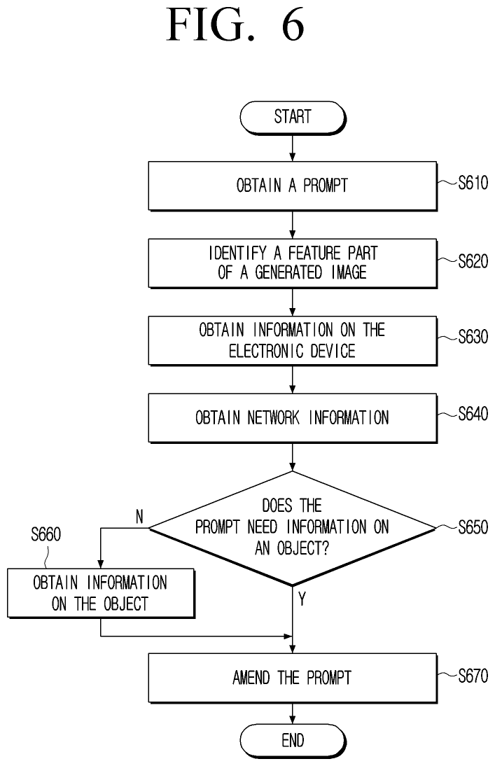

The electronic device 100 may modify the prompt in operation S410. The electronic device 100 may modify the prompt based on at least one of the feature part of the generated image, the information on the electronic device 100, the network information, or the information on the object. Explanation in this regard will be described with reference to FIG. 6.

FIG. 6 is a flow chart for illustrating a method of modifying a prompt according to an embodiment.

In the embodiments below, each operation may be performed sequentially, but the operations are not necessarily performed sequentially. For example, the order of each operation may be changed, and at least two operations may be performed in parallel.

According to an embodiment, the operations S610 to S670 may be understood to be performed at the processor (e.g.: the processor 170 in FIG. 2) of the electronic device (e.g.: the electronic device 100 in FIG. 2).

The electronic device 100 may obtain a prompt in operation S610. For additional implementation details, reference may be made to the descriptions of operation S405 of FIG. 4.

Here, the electronic device 100 may identify a feature part of a generated image in operation S620. The electronic device 100 may identify a feature part of a generated image by identifying a target word (or a main keyword) corresponding to an image that the user desires to generate among a plurality of words included in the prompt. According to an embodiment, the electronic device 100 may identify a target word by inputting the input prompt into the trained neural network model. According to another embodiment, the electronic device 100 may identify a keyword selected through the category UI element 510 among the plurality of UI elements included in the UI 500 as a target word. According to still another embodiment, the electronic device 100 may identify a target word by identifying an object among the plurality of words included in the prompt.

The electronic device 100 may identify information on the electronic device 100 in operation S630. Here, the information on the electronic device 100 may include identification information of the electronic device 100 and performance information of the electronic device 100. Here, the identification information of the electronic device 100 may include information on the product name, the product number, and the manufacturer of the electronic device 100. The performance information of the electronic device 100 may include use information of the processor 170, use information of the memory 150, battery information of the electronic device 100, display information of the electronic device 100, for example

The electronic device 100 may obtain network information in operation S640. Here, the information on the network performance may include at least one of information on the bandwidth, information on the delay time, information on a jitter, information on a packet loss, information on a throughput, or information on the quality of service (QoS). The electronic device 100 may obtain information on the delay time and a packet loss through a ping test, and obtain information on the bandwidth (the download/upload time, for example) through a speed test, and evaluate the processing amount and the bandwidth of the network by using an iPerf.

The electronic device 100 may identify whether the prompt indicates information relating to an object is to be obtained in operation S650. The electronic device 100 may identify whether a word related to an object stored inside the electronic device 100 is included among the plurality of words included in the prompt. For example, if a prompt such as “Please generate an image with food in the refrigerator” is obtained, the electronic device 100 may identify that a word related to an object stored inside the electronic device 100 such as “food in the refrigerator” is included among the plurality of words included in the prompt. The electronic device 100 may identify that the prompt indicates information relating to the object is to be obtained.

If it is identified that the information relating to the object is to be obtained in operation S650-Y, the electronic device 100 may obtain information on the object in operation S660. The electronic device 100 may input an image of the inside of the electronic device 100 photographed by the camera 130 into the trained neural network model, and obtain information on the object included in the image of the inside. The electronic device 100 may obtain information on the object that the user input when storing the object inside the electronic device 100.

The electronic device 100 may modify the prompt in operation S670. According to an embodiment, the electronic device 100 may modify the prompt to include a text that makes an area corresponding to the feature part of the image generated in a high image quality, and makes an area corresponding to the surrounding part of the image generated in a low image quality based on the feature part of the image. According to an embodiment, if a prompt which is “Please draw a dish that can be made with food in the refrigerator” is input, the electronic device 100 may identify the feature part of the image as “a dish,” and modify the prompt to include a text which is “Generate the dish part in each image to be clear, and generate the remaining parts to be blurry.” According to an embodiment, the electronic device 100 may modify the prompt to include a text that makes the second image quality of the generated image and whether to compress the image determined based on the information on the electronic device 100 and the network information. As an example, the electronic device 100 may modify the prompt to include a text such as “Please determine the quality level of the image quality according to the identified network speed (x bps). Please determine whether to compress the image according to the specification of the electronic device 100 (an XYY product).” According to an embodiment, the electronic device 100 may modify the prompt to add information on an object. For example, if a prompt which is “Please draw a dish that can be made with food in the refrigerator” is input, the electronic device 100 may modify the prompt to include a text such as “Please draw a dish that can be made with kimchi in the refrigerator” based on the information on the object.

Explaining about FIG. 4 again, the electronic device 100 may transmit the modified prompt to the external server 200 in operation S420.

The external server 200 may obtain a plurality of candidate images based on the modified prompt in operation S425. The external server 200 may obtain a plurality of candidate images by inputting the modified prompt into the generative AI model. For example, if a prompt which is “Please draw a dish that can be made with kimchi in the refrigerator” is input, the external server 200 may generate a plurality of candidate images including a dish related to kimchi by using the generative AI model. Here, the plurality of generated candidate images may be images of a low image quality. The external server 200 may obtain seed values indicating the plurality of candidate images together with the plurality of candidate images.

The external server 200 may adjust the image quality of the plurality of candidate images according to the network speed and the performance of the electronic device. For example, in case the network speed is greater than or equal to a threshold value or the performance of the electronic device 100 is high performance, the external server 200 may transmit the plurality of candidate images of the first image quality, and in case the network speed is smaller than the threshold value or the performance of the electronic device 100 is low performance, the external server 200 may transmit the plurality of candidate images that were compressed.

The external server 200 may transmit the plurality of candidate images to the electronic device 100 in operation S430.

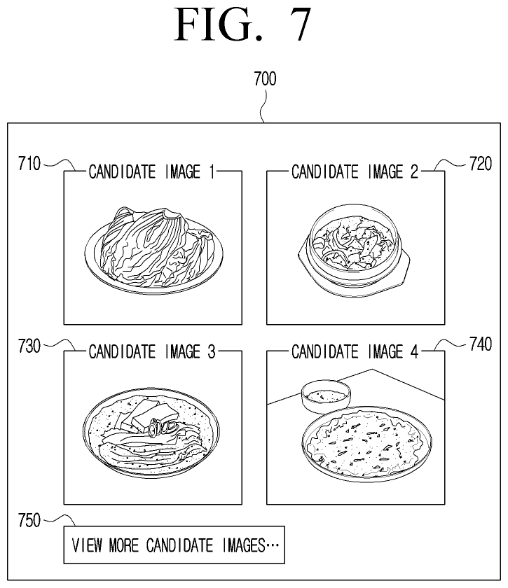

The electronic device 100 may display a UI including the plurality of candidate images in operation S440. For example, as illustrated in FIG. 7, the electronic device 100 may display a UI 700 including the plurality of candidate images 710 to 740 of a low image quality. Here, in case an image desired by the user does not exist among the candidate images, the electronic device 100 may include a “view more candidate images” UI element 750 for generating additional candidate images. For example, if the “view more candidate images” UI element 750 is selected, the electronic device 100 may transmit a request signal for generating additional candidate images to the external server 200.

While the electronic device 100 is providing the plurality of candidate images, the external server 200 may obtain generated images corresponding to the plurality of candidate images in operation S445. For example, the external server 200 may obtain generated images corresponding to the plurality of candidate images regardless of the user's selection of a candidate image. Here, the external server 200 may obtain generated images whose image quality has been improved by using at least one neural network model. According to an embodiment, the at least one neural network model is a model for improving an image quality of an input image, and may include an upscaling model and a refining model. The external server 200 may improve the image quality of the candidate images by using seed values indicating the plurality of candidate images.

The electronic device 100 may select one of the plurality of candidate images according to a user input in operation S450. For example, if a user input selecting one candidate image is detected through the UI illustrated in FIG. 7, the electronic device 100 may select one of the plurality of candidate images based on the user input.

The electronic device 100 may transmit information on the selected candidate image to the external server 200 in operation S455. Here, the information on the selected candidate image may be identification information of the selected candidate image or a seed value corresponding to the selected candidate image.

The external server 200 may transmit a generated image corresponding to the selected candidate image to the electronic device 100 in operation S460. For example, the external server 200 may identify a generated image corresponding to the selected candidate image among the plurality of generated images based on the information received from the electronic device 100. The external server 200 may transmit the identified generated image to the electronic device 100.

The electronic device 100 may provide the received generated image in operation S465. The electronic device 100 may provide the generated image through the display 120, and provide the generated image to an external user terminal. According to an embodiment, the electronic device 100 may automatically set the generated image as a background screen.

FIG. 8 is a sequence diagram for illustrating an embodiment for obtaining an image corresponding to a prompt according to another embodiment. In the embodiments below, each operation may be performed sequentially, but the operations are not necessarily performed sequentially. For example, the order of each operation may be changed, and at least two operations may be performed in parallel. For additional implementation details of operations S805 and S810 of FIG. 8, reference may be made to the descriptions of operations of S405 and S410 of FIG. 4.

The electronic device 100 may obtain a plurality of candidate images by using the modified prompt in operation S815. The electronic device 100 may obtain a plurality of candidate images by inputting the modified prompt into the generative AI model. Here, the plurality of generated candidate images may be images of a low image quality. The electronic device 100 may obtain seed values indicating the plurality of candidate images together with the plurality of candidate images.

The electronic device 100 may transmit information on the plurality of candidate images to the external server 200 in operation S820. Here, the information on the plurality of candidate images may be seed values indicating the plurality of candidate images, but is not limited thereto.

The electronic device 100 may display a UI including the plurality of candidate images in operation S825. For example, as illustrated in FIG. 7, the electronic device 100 may display a UI 700 including the plurality of candidate images 710 to 740 of a low image quality.

While the electronic device 100 is providing the plurality of candidate images, the external server 200 may obtain generated images corresponding to the plurality of candidate images in operation S830. Here, the external server 200 may obtain generated images corresponding to the plurality of candidate images by using the seed values. The external server 200 may obtain generated images whose image quality has been improved by using at least one neural network model.

The electronic device 100 may select one of the plurality of candidate images according to a user input in operation S840. For example, if a user input selecting one candidate image is detected through the UI illustrated in FIG. 7, the electronic device 100 may select one of the plurality of candidate images based on the user input.

The electronic device 100 may transmit information on the selected candidate image to the external server 200 in operation S845. Here, the information on the selected candidate image may be identification information of the selected candidate image or a seed value corresponding to the selected candidate image.

The external server 200 may transmit a generated image corresponding to the selected candidate image to the electronic device 100 in operation S850.

The electronic device 100 may provide the received generated image in operation S855. The electronic device 100 may provide the generated image through the display 120, and provide the generated image to an external user terminal. According to an embodiment, the electronic device 100 may automatically set the generated image as a background screen.

As explained in the FIG. 4 to FIG. 8, an image improvement task is performed at the external server 200, and thus an image improvement task that was impossible in the electronic device 100 in the past can be performed by the external server 200 in a short time of hundreds of milliseconds. For example, the processing time can be reduced greatly. As the operational burden of the electronic device 100 is reduced, contribution is made to maintenance of the performance of the electronic device 100 together with extension of the battery life, and it becomes possible to allot more resources to other tasks. As the external server 200 performs an image improvement task, a generated image of more improved quality can be obtained. The user experience can be improved by virtue of fast image processing and improved image quality. Not only that, an optimal generated image can be provided by reflecting a user prompt, the network environment, and information on the electronic device.

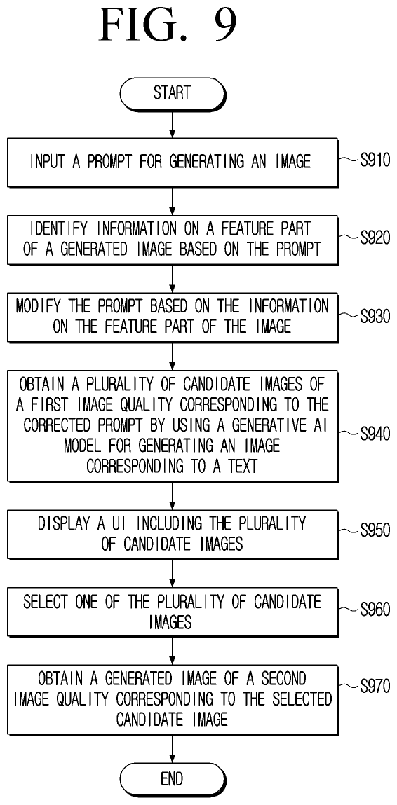

FIG. 9 is a flow chart for illustrating a controlling method of an electronic device for obtaining an image corresponding to a prompt according to an embodiment.

In the embodiments below, each operation may be performed sequentially, but the operations are not necessarily performed sequentially. For example, the order of each operation may be changed, and at least two operations may be performed in parallel.

According to an embodiment, the operations S910 to S970 may be understood to be performed at the processor (for example, the processor 170 in FIG. 2) of the electronic device (for example, the electronic device 100 in FIG. 2).

The electronic device 100 receives input of a prompt for generating an image in operation S910.

The electronic device 100 identifies information in a portion of a generated image based on the prompt in operation S920.

The electronic device 100 corrects the prompt based on the information on the feature part of the image in operation S930. According to an embodiment, the electronic device 100 may modify the prompt to include a text that makes an area corresponding to the feature part of the image generated in a high image quality, and makes an area corresponding to the surrounding part of the image generated in a low image quality.

The electronic device 100 obtains a plurality of candidate images of a first image quality corresponding to the modified prompt by using a generative AI model for generating an image corresponding to a text in operation S940. According to an embodiment, the electronic device 100 may transmit the modified prompt to the external server 200, and based on the plurality of candidate images being obtained as the external server 200 inputs the modified prompt into the generative AI model, receive the plurality of candidate images from the external server 200. The external server 200 may obtain the plurality of candidate images and seed values indicating each of the plurality of candidate images by using a generative AI model for generating an image corresponding to a text.

According to an embodiment, the electronic device 100 may obtain the plurality of candidate images of the first image quality corresponding to the modified prompt by inputting the modified prompt into the generative AI model. The electronic device 100 may, while displaying a UI including the plurality of candidate images, transmit the plurality of candidate images and seed values indicating each of the plurality of candidate images to the external server 200.

The external server 200 may obtain a plurality of images corresponding to the plurality of candidate images by using at least one neural network model for improvement of an image quality after transmitting the plurality of candidate images.

The electronic device 100 provides a UI including the plurality of candidate images in operation S950.

The electronic device 100 selects one of the plurality of candidate images in operation S960.

The electronic device 100 obtains a generated image of a second image quality corresponding to the selected candidate image in operation S970. Here, the second image quality may be a higher image quality than the first image quality. According to an embodiment, based on one of the plurality of candidate images being selected, the electronic device 100 may receive the generated image of the second image quality corresponding to the selected candidate image among the plurality of images from the external server 200. The electronic device 100 may receive the generated image of the second image quality corresponding to the selected candidate image obtained by using a seed value corresponding to the selected candidate image.

According to an embodiment, the electronic device 100 may modify the prompt to include a text that makes the second image quality of the generated image and whether to compress the image determined based on information on the electronic device 100 and network information.

According to an embodiment, the electronic device 100 may capture an image of the interior of the electronic device 100 through the camera 130, and obtain information on an object included in the image of the interior. The electronic device 100 may modify the prompt by adding the information on the object to the prompt.

According to an embodiment, the electronic device 100 may set the generated image as a background screen of the electronic device 100.

The method according to the various embodiments may be provided while being included in a computer program product. A computer program product refers to a product, and it can be traded between a seller and a buyer. A computer program product can be distributed in the form of a storage medium that is readable by machines (e.g.: compact disc read only memory (CD-ROM)), or can be distributed on-line (e.g.: download or upload) through an application store (e.g.: Play Store™) or directly between two user devices (e.g.: smartphones). In the case of on-line distribution, at least a portion of a computer program product (e.g.: a downloadable app) may be stored in a storage medium such as the server of the manufacturer, the server of the application store, and the memory of the relay server at least temporarily, or may be generated temporarily.

The method according to the various embodiments may be implemented as software including instructions stored in machine-readable storage media, which can be read by machines (e.g.: computers). The machines refer to devices that call instructions stored in a storage medium, and can operate according to the called instructions, and the devices may include an electronic device according to the embodiments (e.g.: a TV).

A storage medium readable by machines may be provided in the form of a non-transitory storage medium. Here, the term ‘a non-transitory storage medium’ only means that a storage medium is a tangible device, and does not include signals (e.g.: electromagnetic waves), and the term does not distinguish a case wherein data is stored in the storage medium semi-permanently and a case wherein data is stored temporarily. For example, ‘a non-transitory storage medium’ may include a buffer wherein data is temporarily stored.

In case an instruction as described above is executed by a processor, the processor may perform a function corresponding to the instruction by itself, or by using other components under its control. An instruction may include a code that is generated or executed by a compiler or an interpreter.

While embodiments have been shown and described, the disclosure is not limited to the embodiments, and it is apparent that various modifications may be made by those having ordinary skill in the technical field to which the disclosure belongs, without departing from the scope of the disclosure as claimed by the appended claims. It is intended that such modifications are not to be interpreted independently from the technical idea or prospect of the disclosure.

What is claimed is:

1. An electronic device comprising:
memory storing one or more instructions; and
at least one processor,
wherein the one or more instructions, when executed by the at least one processor individually or collectively, cause the electronic device to:
receive an input prompt;
identify feature information in a first portion of a first generated image based on the input prompt;
obtain a modified prompt by modifying the input prompt based on the feature information;
obtain a plurality of candidate images of a first image quality corresponding to the modified prompt using a first generative artificial intelligence (AI) model for generating an output image based on input text;
display a user interface (UI) comprising the plurality of candidate images via a display; and
based on a selected candidate image being identified from among the plurality of candidate images, obtain a second generated image of a second image quality corresponding to the selected candidate image, wherein a second image quality parameter of the second generated image is higher than a first image quality parameter of the first generated image.

2. The electronic device of claim 1, wherein the one or more instructions, when executed by the at least one processor individually or collectively, cause the electronic device to:
modify the input prompt to include text indicating to:
modify a first area corresponding to the first portion of the first generated image to increase a third image quality parameter in the first area, and
modify a second area corresponding to a second portion of the first generated image surrounding the first portion to decrease a fourth image quality parameter in the second area.

3. The electronic device of claim 1, further comprising a communication interface,
wherein the one or more instructions, when executed by the at least one processor individually or collectively, cause the electronic device to:
modify the input prompt to include text indicating to:
generate the second generated image with the second image quality, and
based on information obtained from at least one of the memory or a network via the communication interface, compress the second generated image.

4. The electronic device of claim 1, further comprising a communication interface,
wherein the first generative AI model is stored in a storage of an external server, and
wherein the one or more instructions, when executed by the at least one processor individually or collectively, cause the electronic device to:
transmit the modified prompt to the external server via the communication interface to cause the external server to input the modified prompt into the first generative AI model; and
receive the plurality of candidate images from the external server while the external server processes the modified prompt via the first generative AI model.

5. The electronic device of claim 4, wherein the electronic device causes the external server to generate a plurality of images corresponding to the plurality of candidate images, via at least one neural network model for increasing at least one image quality parameter, based on the electronic device requesting the plurality of candidate images, and
wherein the one or more instructions, when executed by the at least one processor individually or collectively, cause the electronic device to, based on the selected candidate image being identified, receive the second generated image from the external server via the communication interface.

6. The electronic device of claim 5, wherein the electronic device causes the external server to obtain a plurality of seed values corresponding to the plurality of candidate images, via a second generative AI model for generating an output image based on input text, based on the electronic device requesting the plurality of candidate images, and
wherein the one or more instructions, when executed by the at least one processor individually or collectively, cause the electronic device to receive the second generated image from the external server based on transmitting to the external server a seed value corresponding to the selected candidate image.

7. The electronic device of claim 1, further comprising a communication interface,
wherein the first generative AI model is stored the memory, and
wherein the one or more instructions, when executed by the at least one processor individually or collectively, cause the electronic device to:
obtain the plurality of candidate images by inputting the modified prompt into the first generative AI model; and
while displaying the UI comprising the plurality of candidate images, transmit the plurality of candidate images and a plurality of seed values corresponding to the plurality of candidate images to an external server via the communication interface.

8. The electronic device of claim 7, wherein the one or more instructions, when executed by the at least one processor individually or collectively, cause the electronic device to, based on the selected candidate image being identified, receive from the external server, via the communication interface, the second generated image based on transmitting a seed value corresponding to the selected candidate image to the external server.

9. The electronic device of claim 1, further comprising a camera,
wherein the one or more instructions, when executed by the at least one processor individually or collectively, cause the electronic device to:
capture an interior image of the electronic device via the camera;
obtain information relating to an object in the interior image; and
obtain the modified prompt by incorporating the information relating to the object into the input prompt.

10. The electronic device of claim 1, wherein the one or more instructions, when executed by the at least one processor individually or collectively, cause the electronic device to set the second generated image as a background screen of the electronic device.

11. A controlling method of an electronic device comprising:
receiving an input prompt;
identifying feature information in a first portion of a first generated image based on the input prompt;
obtaining a modified prompt by modifying the input prompt based on the feature information;
obtaining a plurality of candidate images of a first image quality corresponding to the modified prompt using a first generative artificial intelligence (AI) model for generating an output image based on input text;
displaying a user interface (UI) comprising the plurality of candidate images via a display; and
based on a selected candidate image being identified from among the plurality of candidate images, obtaining a second generated image of a second image quality corresponding to the selected candidate image, wherein a second image quality parameter of the second generated image is higher than a first image quality parameter of the first generated image.

12. The controlling method of claim 11, wherein the obtaining the modified prompt comprises:
modifying the input prompt to include text indicating to:
modify a first area corresponding to the first portion of the first generated image to increase a third image quality parameter in the first area, and
modify a second area corresponding to a second portion of the first generated image surrounding the first portion to decrease a fourth image quality parameter in the second area.

13. The controlling method of claim 11, wherein the obtaining the modified prompt comprises:
modifying the input prompt to include text indicating to:
generate the second generated image with the second image quality, and
based on information obtained from at least one of a memory of the electronic device or a network via a communication interface, compress the second generated image.

14. The controlling method of claim 11, wherein the first generative AI model is stored in a storage of an external server, and
wherein the obtaining the plurality of candidate images comprises:
transmitting the modified prompt to the external server via a communication interface to cause the external server to input the modified prompt into the first generative AI model; and
receiving the plurality of candidate images from the external server while the external server processes the modified prompt via the first generative AI model.

15. The controlling method of claim 14, wherein the external server is caused to generate a plurality of images corresponding to the plurality of candidate images, via at least one neural network model for increasing at least one image quality parameter, based on the electronic device requesting the plurality of candidate images from the external server, and
wherein the obtaining the second generated image comprises, based on the selected candidate image being identified, receiving the second generated image from the external server via the communication interface.

16. The controlling method of claim 15, wherein the external server is caused to obtain a plurality of seed values corresponding to the plurality of candidate images, via a second generative AI model for generating an output image based on input text, based on requesting the plurality of candidate images, and
wherein the obtaining the second generated image comprises receiving the second generated image from the external server based on transmitting to the external server a seed value corresponding to the selected candidate image.

17. The controlling method of claim 11, wherein the first generative AI model is stored memory of the electronic device,
wherein the obtaining the plurality of candidate images comprises obtaining the plurality of candidate images by inputting the modified prompt into the first generative AI model, and
wherein the obtaining the second generated image comprises, while displaying the UI comprising the plurality of candidate images, transmitting the plurality of candidate images and a plurality of seed values corresponding to the plurality of candidate images to an external server via a communication interface.

18. The controlling method of claim 17, wherein the obtaining the second generated image comprises, based on the selected candidate image being identified, receiving from the external server, via the communication interface, the second generated image based on transmitting a seed value corresponding to the selected candidate image to the external server.

19. The controlling method of claim 11, further comprising:
capturing an interior image of the electronic device via a camera;
obtaining information relating to an object in the interior image; and
obtaining the modified prompt by incorporating the information relating to the object into the input prompt.

20. A non-transitory computer-readable recording medium having instructions recorded thereon, that, when executed by at least one processor individually or collectively, cause the at least one processor to:
receive an input prompt;
identify feature information in a first portion of a first generated image based on the input prompt;
obtain a modified prompt by modifying the input prompt based on the feature information;
obtain a plurality of candidate images of a first image quality corresponding to the modified prompt using a first generative artificial intelligence (AI) model for generating an output image based on input text;
display a user interface (UI) comprising the plurality of candidate images via a display; and
based on a selected candidate image being identified from among the plurality of candidate images, obtain a second generated image of a second image quality corresponding to the selected candidate image, wherein a second image quality parameter of the second generated image is higher than a first image quality parameter of the first generated image.
